(19) United States
(12) Patent Application Publication
(10) Pub. No.: US 2026/0348264 A1
(43) Pub. Date: Nov. 5, 2026

(54) SYSTEMS AND METHODS FOR SYNTHESIZING EQUIPMENT DATA

(71) Applicant: Schlumberger Technology Corporation, Sugar Land, TX (US)

(72) Inventors: Saradh Tiwari, Lysaker (NO); Justo Elias Matheus Valero, Lysaker (NO); Waldemar Szemat, Lysaker (NO); Darwin Amaya, Sugar Land, TX (US)

(21) Appl. No.: 19/196,918

(22) Filed: May 2, 2025

(51) Int. Cl. E21B 44/00; E21B 47/12; G06F 16/22

(52) U.S. Cl. CPC E21B 44/00; E21B 47/12; G06F 16/2237; E21B 2200/20

(57) ABSTRACT

A method for generating wellbore equipment responses using a generative artificial intelligence (AI) model includes generating, using an embedding model, a vector index of vector embeddings of equipment documents for wellbore equipment. A wellbore query vector embedding is generated for a wellbore equipment request and compared to the vector index to identify a subset of the vector embeddings in the vector index that match a semantic meaning of the wellbore equipment request. The method includes providing the subset of vector embeddings and a wellbore equipment prompt to a generative AI model instructing the generative AI model to generate a wellbore equipment response using the subset of vector embeddings. The wellbore equipment response is provided to a client device based on receiving the wellbore equipment response from the generative AI model.

### BACKGROUND

Information regarding equipment in the oil and gas industry may often be documented in a repository or data storage. It may be advantageous to discover and synthesize wellbore equipment information from a large and diverse data repository for performing various tasks in an efficient, complete, and effective manner.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings.

FIG. 1-1 illustrates an example environment in which a wellbore equipment request system is implemented, according to at least one embodiment of the present disclosure.

FIG. 1-2 illustrates an example implementation of the wellbore equipment request system as described herein, according to at least one embodiment of the present disclosure.

FIGS. 2-1 to 2-4 illustrate various workflows of the wellbore equipment request system, according to at least one embodiment of the present disclosure.

FIG. 3 illustrates a flow diagram for a method or a series of acts for generating wellbore equipment responses using a generative artificial intelligence (AI) model, according to at least one embodiment of the present disclosure.

FIG. 4 illustrates certain components that may be included within a computing system.

### DETAILED DESCRIPTION

This disclosure generally relates to systems and methods for utilizing generative artificial intelligence (AI) models to synthesize wellbore equipment information originating from a variety of sources. For instance, a computer-implemented wellbore equipment request system is described herein which may facilitate generating wellbore equipment responses using a generative AI model. For example, wellbore equipment responses may be generated responsive to a query, request, question, task, etc., related to wellbore (e.g., oil and gas, or downhole) equipment, which may rely on discovering and/or synthesizing wellbore equipment information contained in a repository of equipment documents. In many cases, the repository may be large and may contain a considerable amount of equipment documents in a variety of different forms, including unstructured formats. The wellbore equipment request system may leverage generative AI models to discover wellbore equipment information relevant to a given request or query in the equipment documents and may synthesize this relevant wellbore equipment information to generate the wellbore equipment response. For example, equipment documents may be embedded and/or stored in a vector index, and some of or the entire vector index may be provided to a generative AI model for generating wellbore equipment responses based on the embedded equipment documents. Wellbore equipment responses may provide information related to interpreting wellbore data, troubleshooting wellbore equipment, facilitating operations of wellbore equipment, providing notifications related to wellbore operations, instructing the use and/or operation of wellbore equipment, among other responses related to wellbore equipment.

In some embodiments, the wellbore equipment request system may generate wellbore equipment responses in this way based on maintaining a vector index of an embedding space for the equipment documents in the data repository. For example, the wellbore equipment request system may perform one or more of parse equipment documents, extract text, tables, images and/or other information from the equipment documents, segment this information to generate vector embeddings in a multi-dimensional embedding and/or vector space, which may be indexed into a vector index or vector database and associated with corresponding metadata related to the underlying equipment documents, other acts, or combinations thereof. By doing so, the wellbore equipment request system, in some embodiments, embeds and correlates wellbore equipment information contained in the equipment documents into the vector index for quantifying and/or characterizing various aspects, qualities, contexts, etc., of the information in the equipment documents.

The wellbore equipment request system may accordingly be implemented to receive wellbore equipment queries and generate wellbore equipment responses responsive to the queries based on the wellbore equipment information in the equipment documents by using the vector index. For example, the wellbore equipment request system generates a wellbore equipment prompt based on the wellbore equipment request and provides the prompt, together with various vector embeddings of the vector index, to a generative AI model for responding to the prompt and/or request. The generative AI model may discover, utilize, and/or access one or more of the vector embeddings based on the vector index and may generate a wellbore equipment response that may be a synthesis, combination, and/or synergy of wellbore equipment information relevant to the wellbore equipment request. For instance, in some cases, the wellbore equipment request queries for or requests information regarding troubleshooting, instructions for operating, or suggestions for adjusting a downhole tool such as a downhole steering tool (e.g., rotary steerable system or RSS). In some cases, the wellbore equipment request queries for or requests data to be interpreted, analyzed, or simulated. In some cases, the wellbore equipment request is implemented in connection with one or more automated or automatic functions of a wellbore equipment request system for operating wellbore equipment. For example, wellbore equipment queries may be associated with monitoring the real time operation of wellbore equipment and presenting notifications related to the operation of the wellbore equipment based on the information in the equipment documents. For instance, wellbore equipment queries may facilitate providing directions for adjusting the operation of wellbore equipment, and in some cases may facilitate implementing automatic adjustments, based on the subject matter knowledge contained in the equipment documents. In some cases, wellbore equipment queries may facilitate calling functions to obtain additional information not initially included in the equipment documents and to embed the additional information into the vector index. In this way, by leveraging generative AI, the wellbore equipment request system may facilitate a variety of different requests for information, suggestions for operation, and/or automatic actions related to wellbore equipment all based on an up-to-date subject matter knowledge base.

As will be discussed in further detail below, the present disclosure includes a number of technical benefits and practical applications described herein that solve problems associated with discovering and synthesizing wellbore equipment information from numerous equipment documents using embedding models and generative AI models. Some example benefits are discussed herein in connection with various features and functionalities provided by a wellbore equipment request system implemented on one or more computing devices. Benefits explicitly discussed in connection with one or more embodiments described herein are provided by way of example and are not intended to be an exhaustive list of all possible benefits of the wellbore equipment request system.

To elaborate, while generative AI models are implemented for performing a wide variety of tasks, they are, however, faced with practical limits related to token limits, which may limit the amount of input information that generative AI models can take in. Accordingly, token limits can significantly limit the usefulness of generative AI models for being implemented in connection with large data stores of information, such as the repository of equipment documents as described herein. For example, due to these token limits, it may not be practical or even possible to directly provide a large number of equipment documents to a generative AI model and query the model with respect to these equipment documents.

The wellbore equipment request system described herein, however, may be advantageously implemented notwithstanding token limits by leveraging retrieval-augmented generation (RAG) techniques. Indeed, the wellbore equipment request system may make requests of generative AI models with respect to a considerable (e.g., most or all) repository of equipment documents by pre-processing and/or pre-embedding the wellbore equipment information of the equipment documents, and providing this pre-embedded information to the generative AI models as the vector index (or as one or more vector embeddings from the vector index). Thus, a generative AI model may be given a specific prompt or request and may reference and/or traverse the embedding space of the vector index representative of a large data repository in order to generate wellbore equipment responses that are responsive to the prompt. Indeed, the wellbore equipment request system described herein facilitates discovering and synthesizing information from a considerable number of sources with a generative AI model that would otherwise not be feasible due to token limits.

The wellbore equipment request system also provides valuable flexibility benefits for performing tasks and generating responses with respect to the repository of equipment documents. For example, some conventional solutions that directly provide equipment documents to a generative AI model as input data to generate wellbore equipment response may require larger, more sophisticated, and/or more robust generative AI models, such as those having higher token limits. In contrast, because the wellbore equipment request system may circumvent conventional challenges associated with token limits in the advantageous way described herein, wellbore equipment response may be generated by generative AI models, for example, that are smaller, less complex, and/or more economical than would otherwise be the case, providing flexibility of implementing such a system. For instance, the wellbore equipment request system and/or the associated generative AI model(s) may be implemented on local and/or offline computing devices, for example, without being limited to sophisticated, robust, and/or specialized computing resources and/or cloud computing systems.

Additionally, by generating the vector embeddings and vector index based on parsing and extracting information from the equipment documents, the wellbore equipment request system provides further adaptability to a wide variety of document formats, includes unstructured formats. In this way, the wellbore equipment request system may be implemented in connection with a number of different subject matter domains and with respect to data repositories having a number of different forms of data stored therein. Indeed, in many domains and/or subject matter areas, equipment documents may be updated, replaced, and/or augmented from time to time as technological advances are made in a given field. It may be impractical or even impossible for other systems or personnel to maintain a current understanding or knowledge of a subject matter as updates are made, which comes at the expense of operating wellbore equipment incorrectly or inefficiently. By relying on, and maintaining up to date, the vector index representing the information contained in the repository of equipment documents the wellbore equipment request system may facilitate decisions and/or actions being taken on a correct, current, and accurate basis.

Further, the wellbore equipment request system pre-processes and/or pre-embeds the wellbore equipment information of the equipment documents for providing to a generative AI model in such a way that the underlying information is not lost to the generative AI model despite the equipment documents not being directly provided as input to the generative AI model. For instance, metadata is associated with each vector embedding corresponding to the underlying equipment documents, providing redundancy of information. In some cases, the metadata includes the underlying wellbore equipment information (e.g., text) or else refers back to an underlying equipment document where the wellbore equipment information can be found. In this way, the generative AI model may refer to this redundant information in order to resolve discrepancies, verify information, or otherwise supplement the performance of its task. Moreover, in cases where relevant or accurate information for a given query is not found in the vector index to a sufficient degree, the wellbore equipment request system can implement one or more function calls to obtain new information responsive to the query. For instance, function calls may relate to receiving information from another system or generating information through analysis and/or simulation. By generating embeddings of this new information and adding the new embeddings to the vector index, the wellbore equipment request system can facilitate generating responses to queries that are accurate and relevant, ensuring that the AI model does not hallucinate incorrect information which, if relied on, could be detrimental to the operation of wellbore equipment.

Additional details will now be provided regarding systems described herein in relation to illustrative figures portraying example implementations of a wellbore equipment request system. For instance, various illustrative figures are shown and described herein related to various workflows of the wellbore equipment request system for utilizing generative AI models to synthesize wellbore equipment information to generate wellbore equipment response based on embeddings of various equipment documents.

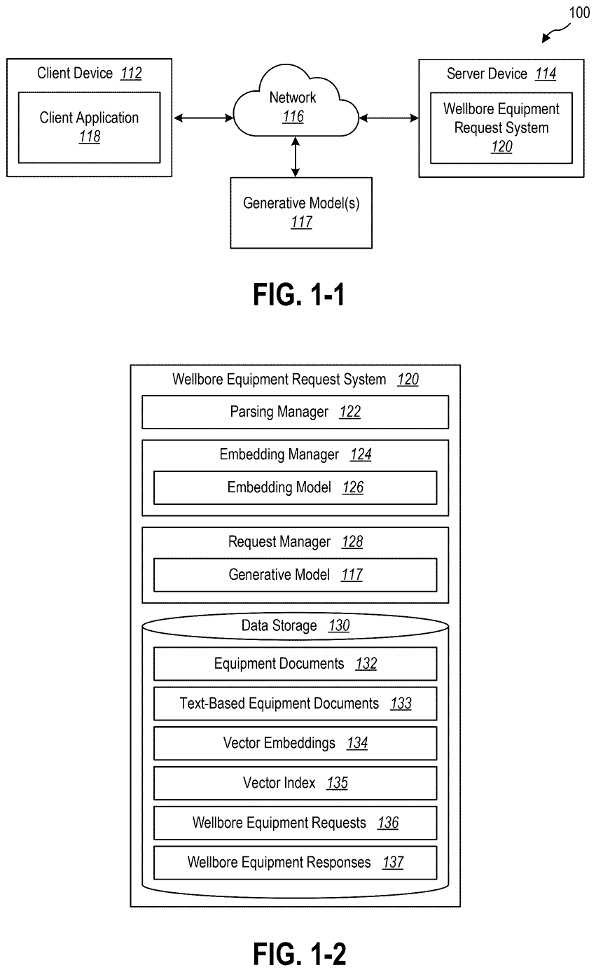

FIG. 1-1 illustrates an example environment 100 in which a wellbore equipment request system 120 is implemented in accordance with one or more embodiments described herein. As shown in FIG. 1-1, the environment 100 includes a server device 114. The server device 114 may include one or more computing devices (e.g., processing units, data storage, etc.) organized in an architecture with various network interfaces for connecting to and providing data management and distribution across one or more client systems. As shown in FIG. 1-1, the server device 114 may be connected to and may communicate with (either directly or indirectly) a client device 112 through a network 116. The network 116 may include one or multiple networks and may use one or more communication platforms and/or technologies suitable for transmitting data. The network 116 may refer to any data link that enables the transportation of electronic data between devices of the environment 100. The network 116 may refer to a hardwired network, a wireless network, or a combination of a hardwired network and a wireless network. In one or more embodiments, the network 116 includes the internet.

The client device 112 may be representative of one or multiple client devices and may refer to various types of computing devices. For example, the client device 112 may include a mobile device such as a mobile telephone, a smartphone, a personal digital assistant (PDA), a tablet, a laptop, or any other portable device. Additionally, or alternatively, the client device 112 may include one or more non-mobile devices such as a desktop computer, server device, processor or computer, or other non-portable device. In one or more implementations, the client device 112 includes a graphical user interface (GUI) thereon (e.g., a screen of a mobile device). In addition, one or more of the client device 112 may be communicatively coupled (e.g., wired or wirelessly) to a display device having a graphical user interface thereon for providing a display of system content.

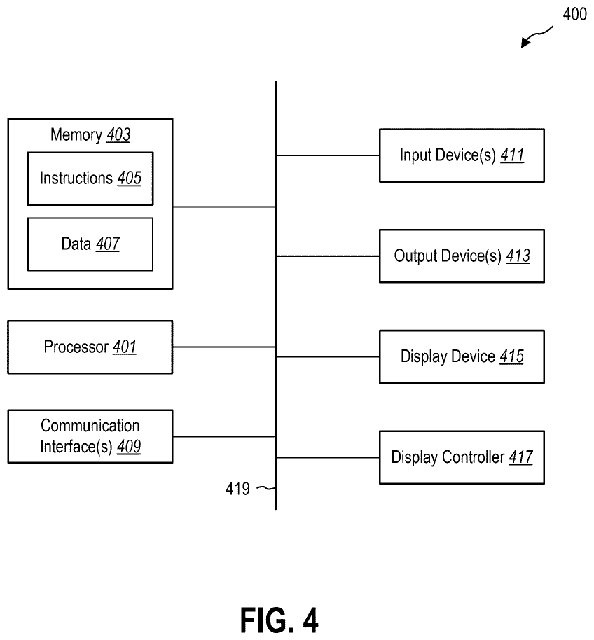

The server device 114 may similarly refer to various types of computing devices. For instance, the server device 114 may be representative of computing components and/or a computing system configured to execute and manage software components of the wellbore equipment request system 120. For example, the server device 114 may facilitate processing, storage, and/or distribution of data necessary for the operation of one or more features of the wellbore equipment request system 120. Each of the devices of the environment 100, such as the server device 114 and/or the client device 112 may include features and/or functionalities described below in connection with FIG. 4.

As shown in FIG. 1-1, the environment 100 may include a wellbore equipment request system 120. While shown on the server device 114, the wellbore equipment request system 120 may be implemented wholly or in part on the client device 112, across the server device 114 and the client device 112, or on or across one or more additional devices, such that different portions or components of the wellbore equipment request system 120 may be implemented on different computing devices in the environment 100. The client device 112 may include a client application 118. In some embodiments, one or more of the functionalities or features of the wellbore equipment request system 120 may be carried out or performed on or by a client application 118. The client application 118 may include an application or interface for interacting with and/or receiving the features of the wellbore equipment request system 120 as described herein. In some cases, the wellbore equipment request system 120 may be implemented across one or more devices.

The environment 100 may include a generative AI model 117. In some embodiments, the generative AI model 117 can be representative of one or more generative AI models. The generative AI models 117 may be accessible to the wellbore equipment request system 120 via the network 116. In some cases, the generative AI models 117 are implemented on or as part of the wellbore equipment request system 120, such as being stored or operated on the server device 114.

As used herein, the terms “generative artificial intelligence model,” “generative AI model,” and “generative model” are used interchangeably and refer to a large or small artificial intelligence system that utilizes deep learning and a large number of parameters (e.g., in the billions or trillions for a large version and fewer for a small version) to generate natural-language based outputs. In many implementations, a generative AI model is trained on one or more extensive datasets to produce coherent, contextually relevant, and fluently topic-specific outputs (e.g., text, graphs, charts, images, and/or other visual content). In many instances, a generative AI model refers to an advanced computational system that uses natural language processing, machine learning, and/or image processing to generate coherent and contextually relevant human-like responses.

Generative AI models have applications in natural language understanding, content generation, text summarization, dialog systems, language translation, creative writing assistance, image generation, audio generation, and more. A single generative AI model often performs a wide range of tasks by receiving different inputs, such as prompts (e.g., input instructions, rules, example inputs, example outputs, and/or tasks), data, and/or access to data. In response, the generative AI model generates various output formats ranging from one-word answers to long narratives, images and videos, labeled datasets, documents, tables, and presentations.

Moreover, generative AI models may primarily be based on transformer architectures to understand, generate, and manipulate human language. Generative AI models can also use other types of architectures such as recurrent neural network (RNN) architecture, long short-term memory (LSTM) model architecture, convolutional neural network (CNN) architecture, or other types of architectures. Examples of generative AI models include generative pre-trained transformer (GPT) models such as GPT-3.5, GPT-4, GPT-4o (including Sora), bidirectional encoder representations from transformers (BERT) model, text-to-text transfer transformer models like T5, conditional transformer language (CTRL) models, and Turing-NLG. Other types of generative AI models include sequence-to-sequence models (Seq2Seq), vanilla RNNs, and LSTM networks. In some cases, generative AI models includes open-source models such as Mistral, Adlik/Llma (Llama), or QWEN. In some instances, a generative AI model includes a large language model (LLM), which serves as a text-based version of a generative AI model, such as a generative AI model that receives text prompts and/or generates text outputs. In various implementations, a generative AI model is a multimodal generative model that receives multiple input formats (e.g., text, tables, images, video, data structures) and/or generates multiple output formats.

In some cases, as described herein, generative AI models may operate in response to “prompts,” “model prompts,” or “generative AI model prompts,” which refer to a request provided to a generative AI model to create a generative AI model output. For example, as described herein, a wellbore equipment prompt includes instructions for a generative model to generate content comprising a wellbore equipment response. In some cases, a prompt may be a plain language guidance prompt. In some instances, the wellbore equipment request system 120 provides additional information with a prompt, such as a vector index of vector embeddings (or a subset thereof) as described herein. A prompt can include a user-level prompt that includes a user request or query, and/or can include a system-level or meta-level prompt that provides important contextual information and/or general framing information to ensure that the generative AI model understands the correct context, syntax, and grounding information of the data it is processing.

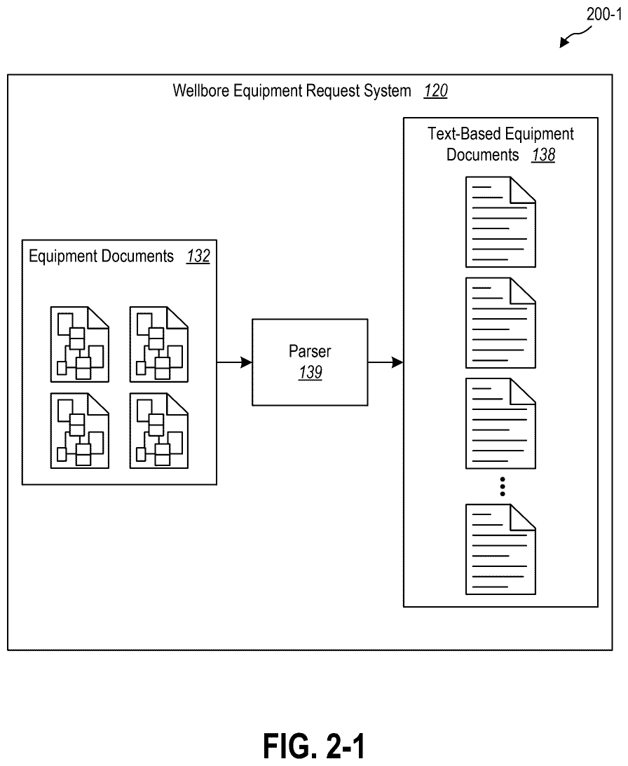

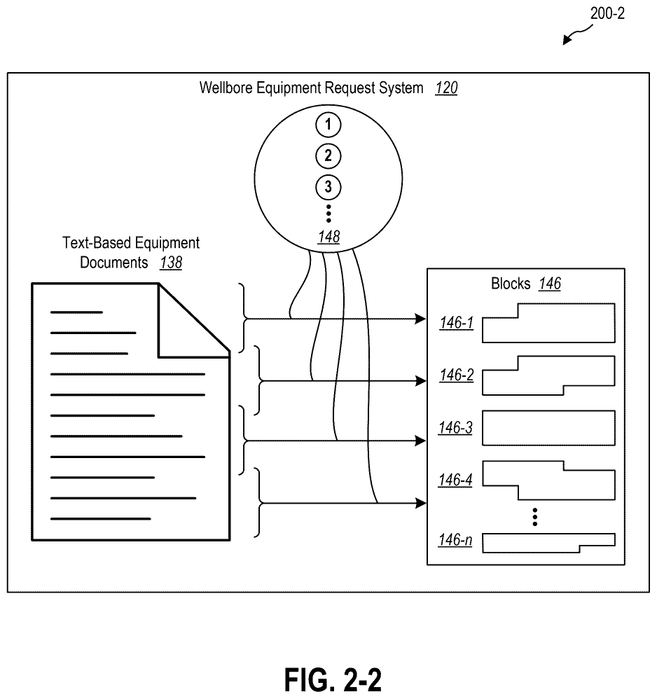

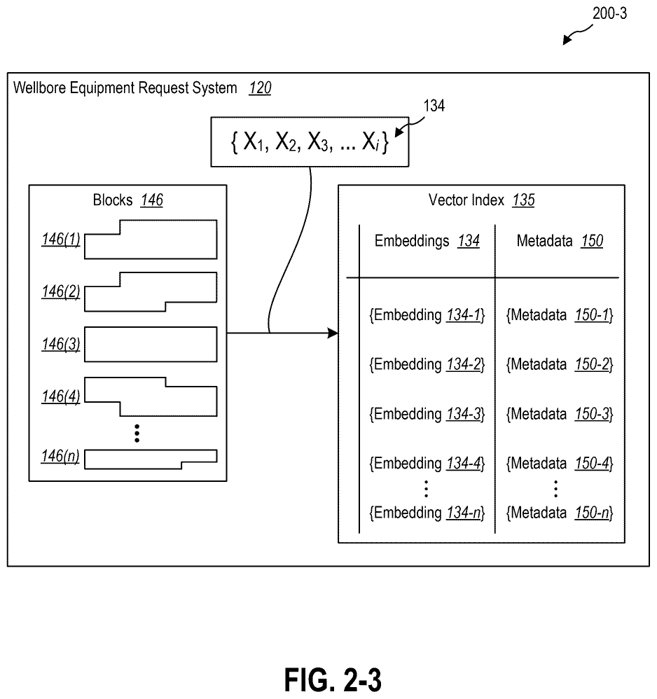

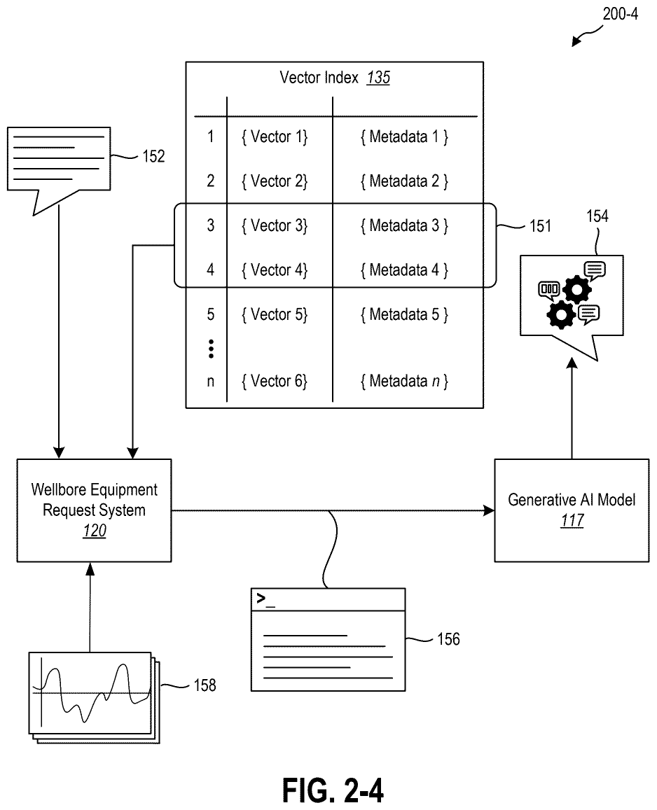

FIG. 1-2 illustrates an example implementation of the wellbore equipment request system 120 as described herein, according to at least one embodiment of the present disclosure. The wellbore equipment request system 120 includes a variety of components for synthesizing equipment data originating from a variety of sources. To illustrate, the wellbore equipment request system 120 includes a parsing manager 122, which may facilitate parsing and/or extracting wellbore equipment information from equipment documents (structured or unstructured) into a computer-readable text format. The wellbore equipment request system 120 includes an embedding manager 124, which facilitates generating vector embeddings of the extracted wellbore equipment information for indexing via a vector index. For example, the embedding manager 124 may include and/or interface with one or more embedding models 126, which may facilitate representing the extracted wellbore equipment information in a high-dimensional vector space, vector database, or similarity space.

The wellbore equipment request system 120 includes a request manager 128, which may be tasked with fielding and responding to requests of the system to create wellbore equipment responses. For example, the request manager 128 may include and/or interface with the generative AI model 117, which may be included in the wellbore equipment request system 120 or located on another device or set of devices. The request manager 128 may administer various features of the generative AI model 117 for generating wellbore equipment responses.

The wellbore equipment request system 120 may also include a data storage 130 having various data stored thereon. For example, the parsing manager 122 may access equipment documents 132 from the data storage 130 and may generate and store text-based equipment documents 133 on the data storage 130. In some embodiments, the equipment documents 132 are stored and/or maintained on the data storage 130 by the wellbore equipment request system 120, or else the equipment documents 132 may be stored on another system and/or storage to which the wellbore equipment request system 120 has access. The embedding manager 124 may generate, from the text-based equipment documents, vector embeddings 134 which may be indexed via a vector index 135. The request manager 128 may receive and/or access wellbore equipment requests 136 and may provide corresponding wellbore equipment responses 137.

While one or more embodiments described herein describe features and functionalities performed by specific components 122-128 of the wellbore equipment request system 120, it will be appreciated that specific features described in connection with one component of the wellbore equipment request system 120 may, in some examples, be performed by one or more of the other components of the wellbore equipment request system 120. By way of example, one or more extractions or parsing features of the parsing manager 122 as described herein may be delegated to other components of the wellbore equipment request system 120. As another example, while vector embeddings may be generated and indexed by the embedding manager 124, in some instances, some or all of these features may be performed by another component of the wellbore equipment request system 120. Indeed, it will be appreciated that some or all of the specific components may be combined into other components and specific functions may be performed by one or across multiple components 122-128 of the wellbore equipment request system 120.

Additionally, while the wellbore equipment request system 120 has been shown and described in connection with FIGS. 1-1 and 1-2 as being implemented on a particular device (e.g., the client device 112 and/or the server device 114), it should be understood that some or all of the features and functionalities of the wellbore equipment request system 120 may be implemented on or across multiple client devices 112 and/or server devices 114. For example, one or more equipment documents 132 may be accessed, and/or parsed by the parsing manager 122 on a (e.g., local) client device, and wellbore equipment responses 137 may be generated by the generative AI model 117, for example, on one or more of a remote, server, or cloud device. Indeed, it will be appreciated that some or all of the specific components 122-128 may be implemented on or across multiple client devices 112 and/or server devices 114, including individual functions of a specific component being performed across multiple devices.

FIGS. 2-1 through 2-4 illustrate various workflows 200-1, 200-2, 200-3, and 200-4 of the wellbore equipment request system 120, according to at least one embodiment of the present disclosure. One or more of the workflows 200-1 to 200-5 may be performed individually, or some or all of the workflows 200-1 to 200-5 may be performed in connection as part of a larger workflow of the wellbore equipment request system 120.

With reference to FIG. 2-1, the wellbore equipment request system 120 may access the data storage 130 and, in particular, may access the equipment documents 132 stored thereon. The data storage 130 may be a library, data store, database, collection of files, repository, or other source of the equipment documents 132, which may be accessible to the wellbore equipment request system 120.

The equipment documents 132 may be any file, document, data, or object, which may include wellbore equipment information associated with wellbore equipment, such as oil and gas equipment, downhole equipment, or any equipment associated with the forming and/or operation of a wellbore. For instance, wellbore equipment may be any equipment, tool, component, and/or system related to one or more of drilling or forming a wellbore, downhole steering, wellbore and/or formation surveying, wellbore completion, resource (e.g., hydrocarbon) production, maintaining a wellbore, capping or sealing a wellbore, surface equipment, or other wellbore equipment, and combinations thereon. In at least one embodiment, the wellbore equipment is downhole steering equipment, such as a rotary steerable system. The equipment documents 132 may include wellbore equipment information, which may be any information, knowledge, subject matter, or data relevant or related to wellbore equipment. For example, the equipment documents 132 may include details related to types and/or specifications of wellbore equipment, operations and/or procedures for utilizing wellbore equipment, designs of wellbore equipment, servicing and/or maintaining wellbore equipment, or any other type of data relevant to wellbore equipment. In at least one embodiment, the equipment documents include operating manuals, concept manuals, service manuals, and/or specification manuals for wellbore equipment. The equipment documents 132 may contain the wellbore equipment information in any number of different forms. For example, the equipment documents 132 may include reports, logs, plans, specifications, manuals, designs, bills of materials, procedures, charts, measurement data, or any other document, form, format, or file type that may include the wellbore equipment information. The equipment documents 132 may also be contained in any language. In some cases, the equipment documents 132 are all in the same language, or various equipment documents 132 may be provided in one or more additional languages.

In some cases, the equipment documents 132 may include text and/or may be in a text-based format. For example, the equipment documents 132 may be in a computer-readable format or may readily readable or consumable by a computer system, such as such as a JavaScript Object Notation (JSON) or Extensible Markup Language (XML) format. In one example, the equipment documents 132 include word-processing type documents or the like which have text that is readily readably by a computer. Accordingly, in one or more embodiments, the equipment documents 132 may (e.g., natively) be text-based equipment documents 138.

In some cases, the wellbore equipment request system 120 may generate text-based equipment documents 138 from the equipment documents 132. For instance, in some cases, while the equipment documents 132 may include computer-readable text, a parser 139 may further format, parse, or extract the text from the equipment documents 132 into a particular form, format, organization, or schema of the text-based equipment documents 138 for use by (e.g., later operations of) the wellbore equipment request system 120. More information regarding parsing is described below.

In some cases, one or more of the equipment documents 132 may be in an unstructured format. For instance, the equipment documents 132 may not be organized according to any predetermined data model, form, or schema, such that the equipment documents 132 may not be readily consumed, processed, or evaluated by a computer system. For example, some of the equipment documents 132 may not include predetermined or structured fields containing data in a specific location, structure, or format for input into one or more computing applications. In some instances, the equipment documents 132 are stored in an unstructured image format. For instance, some of the equipment documents 132 may not be in a computer-readable text format, such as a JSON or XML format. In some cases, the equipment documents 132 include PDF documents containing wellbore equipment information that is not in a typical computer-readable format and/or that is not readily readable by a computing system.

In some cases, the equipment documents may be unstructured in that they include unstructured content (e.g., text, tables, images, etc.) that are not readily readable by a computer application and/or are not contained in fields, schema, or other designated forms for being readily received by a computer application. In some embodiments, the equipment documents are unstructured in that they include unstructured text, such as freeform text. In some cases, the equipment documents 132 include digital representations of handwritten text such as in logs, notes, or reports. In some embodiments, the equipment documents 132 are unstructured in that they include unstructured tables, such as information contained in a table-like presentation that is not a tabular object or format. In some embodiments, the equipment documents 132 are unstructured in that they include images. For example, the equipment documents 132 may include unstructured content via PDF documents and/or image documents. In this way, the equipment documents 132 may be unstructured and may include wellbore equipment information in a variety of different forms. In some cases, the equipment documents 132 include a combination of structured (e.g., text-based) and unstructured documents.

In some embodiments, the wellbore equipment request system 120 generates text-based equipment documents 138 from the equipment documents 132 that are in an unstructured format. For example, the wellbore equipment request system 120 may employ the parser 139 for generating the text-based equipment document 138 based on the equipment documents 132. The wellbore equipment request system 120 may generate the text-based equipment documents 138 as textualized or text-based versions of the unstructured content of the equipment documents 132. For example, the text-based equipment documents 138 may be (or may include the underlying wellbore equipment information of) the equipment documents 132 in a computer-readable text format such as a JSON format. The computer-readable text format may be one or more formats that a computing system or application may readily process or consume in order to obtain or access the underlying wellbore equipment information. For example, a computer-readable text format may include extracted text from a source of unstructured text. In another example, a computer-readable text format may include text relaying (and/or summarizing) information from a source of unstructured tables. In some cases, a computer-readable text format includes text describing or summarizing an image, diagram, or figure.

The wellbore equipment request system 120 may generate the text-based equipment documents 138 based on parsing the equipment documents 132. For example, the wellbore equipment request system 120 may utilize a parsing tool, model, or other component to analyze the wellbore equipment information in the (structured or unstructured form of the) equipment documents 132, and may extract, parse, or otherwise convert the wellbore equipment information into the computer-readable text format(s) of the text-based equipment documents 138. The parser(s) 139 may include a parsing tool, a machine learning model such as a generative AI model or large language model (LLM), or another component for generating textualized data of the text-based equipment documents 138. The wellbore equipment request system 120 may generate a text-based equipment document 138 for each equipment document 132, generate multiple text-based equipment documents 138 for each equipment document, and/or generate a text-based equipment document 138 for multiple equipment documents 132. In this way, the wellbore equipment request system 120 may convert each of the equipment documents 132 into a specific computer-readable structure to facilitate the features and functionalities as described herein.

The workflow 200-2 of FIG. 2-2 illustrates an example of generating blocks 146 from the text-based equipment documents 138 for use in embedding into a multi-dimensional embedding or vector space. In some cases, the workflow 200-2 may be performed by the parsing manager 122 of the wellbore equipment request system 120.

After generating the text-based equipment documents 138, the wellbore equipment request system 120 may segment the text of the text-based equipment documents 138 and generate various blocks 146. For instance, the wellbore equipment request system 120 may segment the text-based equipment documents 138 based on a specific number of words, sentences, paragraphs, sections, pages, topics, or other segmenting criteria. For instance, the blocks 146 (i.e., a first block 146-1, a second block 146-2, a third block 146-3, a fourth block 146-4, and so on to an nth block 146-n) may be generated to include a specific number of words, paragraphs, or until a specific size of data is met. In some implementations, the blocks 146 are generated based on a word allocation, paragraph allocation, or other allocation.

In some embodiments, the wellbore equipment request system 120 may tokenize the text-based equipment documents 138 by generating and/or associating tokens 148 from or with the text-based equipment documents 138. For instance, the wellbore equipment request system 120 may convert or otherwise represent one or more words of the text-based equipment documents 138 with the tokens 148 (e.g., Token 1, Token 2, Token 3). In some cases, the wellbore equipment request system 120 may generate the blocks 146 based on a token allocation of a certain quantity of tokens per block 146.

In some embodiments, the blocks 146 may be generated having an overlap between adjacent or consecutive blocks 146. For example, the wellbore equipment request system 120 may generate the blocks 146 based on overlapping a certain number of words, paragraphs, tokens, etc., from one block to a next block. Indeed, the blocks 146 may be generated having a token overlap. As an example, a first block may be generated based on an allocation of tokens 148 (or words, paragraphs, etc.) from 1 to 100, and a second block may be generated based on an allocation of tokens 148 (or words, paragraphs, etc.) from 80 to 180, and so on. In this way, each block may include overlapping information from a previous block and a subsequent block. This overlap may create continuity between consecutive blocks by preserving wellbore equipment information context, meaning, background, and/or perspective, especially for blocks 146 originating from the same equipment document but which may span several blocks.

Indeed, the blocks 146 may represent small excerpts, sections, chunks, or segments of the wellbore equipment information of the equipment documents 132, which may be utilized for embedding segments of the wellbore equipment information into an embedding space (e.g., vector space). The wellbore equipment request system 120 may generate any number of blocks 146, as shown in FIG. 2-2 by blocks 146-1 through 146-n. For instance, in some cases, a text-based equipment document 138 may be segmented as described herein for generating multiple blocks 146. In some embodiments, multiple text-based equipment documents 138 may be combined and represented in a singular block 146. The wellbore equipment request system 120 may generate blocks 146 for representing the wellbore equipment information in the body of equipment documents 132 based on segmenting each of the text-based equipment documents 138.

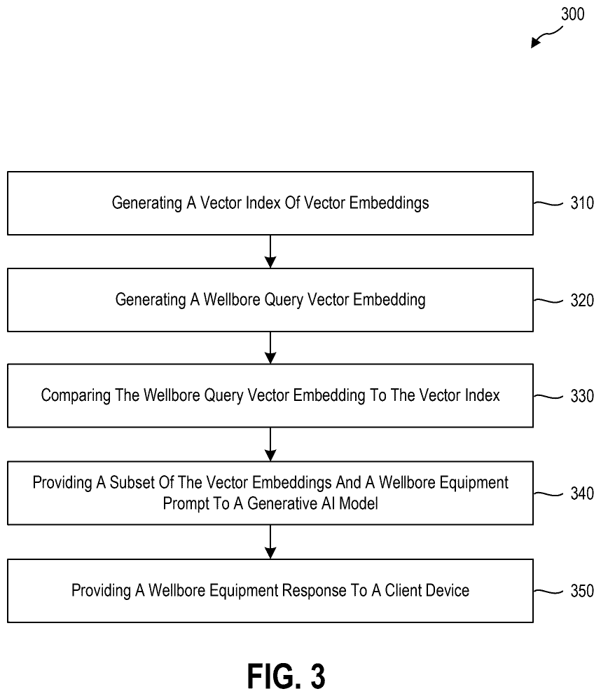

The workflow 200-3 of FIG. 2-3 illustrates an example of generating vector embeddings 134 from the blocks 146 to form a vector index 135. In some cases, the workflow 200-3 is performed by the embedding manager 124 and/or by utilizing the embedding model 126.

After generating the blocks 146, the wellbore equipment request system 120 may generate vector embeddings 134 based on embedding the blocks 146. For example, the wellbore equipment request system 120 may convert the (e.g., textual) data of each block 146 into a high-dimensional numerical representation by mapping the block 146 to a fixed-length vector embedding 134 in a continuous vector space or embedding space. The vector embeddings 134 may capture meaning, semantic relationships, contextual information, etc., from the text of the blocks 146, and represent this information as a set of values corresponding to various qualitative dimensions in a vector form. For instance, the vector embeddings 134 may represent the underlying blocks 146 based on a semantic meaning of the blocks 146, for example, rather than just indicating key words of the blocks 146. The wellbore equipment request system 120 may identify and/or map the content of each block 146 with values x₁ through xᵢ for dimensions 1 through i of the vector index 135 and may store this mapping as a vector embedding 134. In this way, the blocks 146 may be represented in a vector form and mapped to a high-dimensional embedding space for enabling computational processing and similarity (e.g., vector distance) measurements between vector embeddings 134 in the embedding space. The wellbore equipment request system 120 may generate a vector embedding 134 for each block 146 and in this way may relate some or all of the wellbore equipment information contained in the equipment documents via vector representations mapped to the embedding space.

The wellbore equipment request system 120 may store each of the vector embeddings 134 in the vector index 135. For example, the vector index 135 may be an index of each of the vector embeddings 134 corresponding with each of the underlying blocks 146, represented in FIG. 2-3 as vector embeddings 134-1 through 134-n. For instance, the vector index 135 may be a table or other object, which may store or reference the vector embeddings 134. In some instances, the vector index 135 is a stored version of the embedding space, such as a vector database, which includes the vector embeddings 134.

In some embodiments, the vector index 135 may define and/or may include information detailing the mapping of the embedding space. For example, the vector index 135 may define the various dimensions of the embedding space, their meaning or context, etc., which may facilitate providing the vector index 135 to a generative AI model to perform inferencing and/or generate responses based on the vector index 135.

In some embodiments, the wellbore equipment request system 120 may generate metadata 150, and may store or otherwise associate the metadata 150 with the vector embeddings 134 in the vector index 135. For example, the wellbore equipment request system 120 may generate metadata 150-1 through 150-n for the blocks 146, which may correspond to context and/or background information for the underlying wellbore equipment information from which the blocks 146 are derived. For example, each block 146 may correspond to a section of text, one or more tables, and/or one or more images originating from an equipment document, and the metadata 150 may identify a document location of the equipment document from which it originates. The metadata 150 may provide a link or reference to the corresponding equipment document. In some cases, the metadata 150 indicates a location within an equipment document associated with the corresponding block 146. In various examples, the metadata 150 indicates one or more section headings of an equipment document associated with the corresponding block 146. In another example, the metadata 150 may indicate text, context, meaning, significance, background, etc., for a block based on the text, table(s), and/or image(s) that are located surrounding, adjacent, or near the associated content in the underlying equipment document. In various cases, the metadata 150 may include the text, table(s), and/or image(s) corresponding to a block 146 (e.g., in an original or textualized/parsed form), such as a reference to provide redundancy of information, to validate the vector embedding 134, etc.

In some cases, the wellbore equipment request system 120 generates one vector index 135. For example, blocks derived from structured and unstructured equipment documents may be embedded into the same embedding space and stored in the same vector index 135. In another example, blocks derived from any of text sources, table sources, and images sources are contained in the same vector index 135. As mentioned, in some cases the equipment documents may include documents in a variety of different languages. Regardless of the language, the equipment documents may be parsed, segmented into blocks, and embedded into vector embeddings for representing the underlying information in the vector index. Indeed, the vector index may facilitate summarizing, synthesizing, and discovering information across many different languages, based on the semantic meaning of the underlying information. In this way, the wellbore equipment request system 120 may generate the vector embeddings 134 and one or more vector indices 135 as part of a pre-processing or pre-embedding operation to facilitate utilizing a generative AI model to generate wellbore equipment response based on the wellbore equipment information in the equipment documents 132.

In some cases, the vector index 135 may be updated or regenerated one or more times. To elaborate, the equipment documents may be updated, replaced, or modified from time to time as technology advances, as wellbore equipment is updated and/or replaced (e.g., including software updates), or other changes to the equipment documents. In some cases, the wellbore equipment request system 120 may periodically (e.g., once per month, once per quarter, once per year, or other interval) update and/or regenerate the vector index 135 such that the vector embeddings 134 represent a current or up-to-date knowledge base of the equipment documents. In some cases, the vector index 135 may be updated and/or regenerated each time an equipment document is changed, or when a threshold number of the equipment documents are changed. In this way, the vector index 135 may be maintained (e.g., kept up to date) with a subject matter knowledge base.

The workflow 200-4 illustrates an example of generating a wellbore equipment response 154 with a generative AI model 117 responsive to a wellbore equipment request 152. In some embodiments, the workflow 200-4 is performed by the request manager 128 in connection with the generative AI model 117.

In some cases, the wellbore equipment request system 120 receives a wellbore equipment request 152. For example, the wellbore equipment request 152 may be provided by a client device associated with user, such as in a text-based query. In some cases, the wellbore equipment request 152 may be generated and provided by a client device associated with a wellbore equipment system which manages and/or controls the operation of wellbore equipment. For instance, the wellbore equipment requests 152 may be provided by a wellbore equipment system as part of an automated (e.g., automatic, without user input, and/or without user intervention) wellbore operation which may leverage the wellbore equipment request system 120 to automatically monitor one or more wellbore systems, generate alerts or notifications, provide suggestions or instructions for operating wellbore equipment, or make adjustments to the operation of wellbore equipment.

The wellbore equipment request 152 may be associated with generating a wellbore equipment response 154 based on the wellbore equipment information in the equipment documents 132. For example, the wellbore equipment request 152 may be a request for information about a particular system or tool associated with the wellbore. The wellbore equipment request 152 may query about how a tool, process, or operation is performing or operating currently or over a (e.g., recent) measurement period of interest. The wellbore equipment request 152 may query about an operational condition of a tool or process, including suggestions, recommendations, or insights about how to improve, remediate, or change the operational condition. For example, the wellbore equipment request 152 may query about why a tool is jammed, why a tool is not communicating, or other operational condition, including how to react or respond to an observed or identified behavior. In some cases, the wellbore equipment request 152 may query about recommended drilling operational settings (e.g., for an RSS or other steering system), such as RPM and weight on bit (WOB) for a given section of the well or planned trajectory.

Based on the wellbore equipment request 152, the wellbore equipment request system 120 may generate a wellbore equipment prompt 156. The wellbore equipment prompt 156 may include an input query with instructions that guide the generative AI model 117 to produce a relevant, context-specific output. For example, the wellbore equipment prompt 156 may include a system prompt having instructions, context, questions, constraints, examples, formatting guidelines, etc., that instruct the generative AI model 117 how to generate and/or structure a wellbore equipment response.

In some cases, the wellbore equipment request system 120 generates a wellbore query vector embedding from the wellbore equipment request 152. For example, the wellbore equipment request system 120 may embed the wellbore equipment query into the wellbore query vector embedding using the same (or similar) embedding model as used for embedding the vector embeddings 134 of the vector index 135. For example, the wellbore query vector embedding may represent a semantic meaning, context, and/or relationship of the wellbore equipment request 152, mapped to the same vector space as the vector index 135. Accordingly, the wellbore equipment request 152 as shown may be representative, in some cases, of the wellbore query vector embedding.

In some cases, the wellbore equipment request system 120 generates the wellbore equipment prompt 156 by utilizing the vector index 135 in connection with the wellbore equipment request 152 (e.g., in connection with the wellbore query vector embedding). For example, the wellbore equipment request system 120 may apply the vector index 135 to the wellbore query vector embedding. In some cases, the wellbore equipment request system 120 uses the wellbore query vector embedding to identify relevant vector data within the vector index 135 (e.g., extracted vector data 151). For example, the wellbore equipment request system 120 may compare the wellbore query vector embedding to the vector index 135 and may identify a subset of one or more vector embeddings 134 (e.g., extracted vector data 151) in the vector index 135 that match, or are related or similar to, the wellbore query vector embedding to a threshold degree. To elaborate, the extracted vector data 151 may match or correspond to the context and/or meaning of the wellbore equipment request 152. For instance, a match or similarity may be based on any comparison or similarity metric, such as Euclidian distance, cosine similarity, dot product similarity, or other similarity. The extracted vector data 151 (e.g., a subset of the vector embeddings 134) may be determined based on a given number of vector embeddings 134 that are closest (most similar to) the wellbore query vector embedding, based on vector embeddings 134 that are within a threshold distance to the wellbore query vector embedding, or other threshold. In some cases, as described below, the wellbore equipment request system 120 may not (initially) find or identify any (or a minimum threshold number of) vector embeddings 134 that are sufficiently similar to the wellbore query vector embedding, and may perform one or more function calls to find and/or generate addition vector embeddings that are sufficiently similar to the wellbore query vector embedding so at to comprise the extracted vector data 151.

The extracted vector data 151 is provided to the wellbore equipment request system 120 which can generate a wellbore equipment prompt 156 (or a final prompt) from the extracted vector data 151 and the wellbore equipment request 152 (and/or the wellbore query vector embedding). The wellbore equipment request system 120 may then provide the wellbore equipment prompt 156 to the generative AI model 117. Based on the wellbore equipment prompt 156, the generative AI model 117 may generate a wellbore equipment response 154. The wellbore equipment response 154 may include a response, data, information, or other content generated by the generative AI model 117. For example, the generated wellbore equipment response 154 may indicate information responsive to a query for information. In another example, the generated wellbore equipment response 154 may include an interpretation of data. In another example the generated wellbore equipment response may identify or characterize the operation of a tool, process, equipment, etc. In another example, the generated wellbore equipment response 154 may indicated a suggestion, action, or instructions to change, remediate, troubleshoot, or fix a tool, process, or equipment. In another example, the generated wellbore equipment response 154 may include a notification, flag, or alert, that a tool, process, or equipment is not operating correctly, is operating inefficiently, is not operating according to an established plan or schedule, is operating outside of a threshold, or other notification related to wellbore equipment. In some cases, the wellbore equipment response 154 may include instructions, commands, and/or signals for causing a wellbore equipment system to change or adjust the operation of wellbore equipment.

The generative AI model 117 may generate the wellbore equipment response 154 based on one or more of the vector embeddings 134 (e.g., the extracted vector data 151) indicated in the vector index 135. For example, the generative AI model 117 may tokenize and/or embed the wellbore equipment prompt 156 into the same or similar embedding space as the vector index 135. As mentioned, the generative AI model 117 may rely on the extracted vector data 151 that are similar, close to, and/or relevant to the wellbore query vector embedding to generate the wellbore equipment response 154. In some embodiments, the generative AI model 117 may access the full vector index 135 and/or refer to the metadata 150 for one or more vector embeddings 134 to clarify missing information or discrepancies, supplement the vector index 135, and/or validate the generated wellbore equipment response.

The wellbore equipment response 154 may include a natural language response. For example, a user may interact with the wellbore equipment request system 120 through a chat-based interface. The wellbore equipment response 154 may be provided in any language, including language(s) different from that of the wellbore equipment request 152 and/or the equipment documents. In some cases, the wellbore equipment request system 120 and the generative AI model 117 generate (e.g., multiple) wellbore equipment response 154 independent of one another. For example, consecutive wellbore equipment responses 154 may not be based on one another and/or may not build upon one another. In some cases, multiple wellbore equipment responses 154, such as set of responses in a chat session, may be saved or retained for building upon or forming the basis of one or more later responses. In some cases, a user can provide feedback based on the generated wellbore equipment response 154, which may be provided as feedback data to further update or train the wellbore equipment request system 120.

In some cases, the generative AI model 117 provides the wellbore equipment response 154 to a client device, such as through one or more other systems or applications. The wellbore equipment response 154 may include tables, charts, and/or images. In some cases, the wellbore equipment response 154 indicates one or more equipment documents responsive to the wellbore equipment request 152. For example, the wellbore equipment response 154 may indicate one or more equipment documents, or excerpts therefrom, which provide support, context, and/or information associated with the wellbore equipment response generated by the generative AI model 117.

In this way, the wellbore equipment request system 120 may operate to generate and provide wellbore equipment responses 154 that are responsive to wellbore equipment requests 152. In some cases, the wellbore equipment request system 120 operates offline and/or without being connected the internet. For instance, the wellbore equipment request system 120 may be connected to one or more related or internal systems (e.g., an intranet) that correspond with the wellbore and/or wellbore equipment but may not be connected to and/or may not rely on a connection to the internet. For example, the functionality of the wellbore equipment request system 120 may be implemented locally on a computing device as described herein.

As mentioned above, in some cases the wellbore equipment request system 120 may not identify one or more vector embeddings 134 in the vector index 135 that are related to the wellbore equipment request 152. For example, an insufficient number of vector embeddings 134 may be related to the wellbore equipment request 152 and/or vector embeddings 134 may not be related to a sufficient (threshold) degree. In such cases, the wellbore equipment request system 120 may call one or more functions for generating, discovering, or identifying additional information (e.g., additional to the equipment information in the equipment documents) for including in the vector index 135. For example, the wellbore equipment request system 120 may obtain additional information and may generate one or more additional vector embeddings for indexing and/or including in the vector index 135. The wellbore equipment request system 120 may utilize one or more embedding models (e.g., the same or different from that used for the vector embeddings 134) for mapping the additional information to the same embedding space as the vector index 135. Based on the additional information obtained from the function calling, and the corresponding generated vector embeddings, the wellbore equipment request system 120 may identify the extracted vector data 151 for providing to the generative AI model 117 to generate the wellbore equipment response 154.

The wellbore equipment request system 120 may utilize any number of different function calls to obtain the additional information. For example, the function calls may include functions for requesting, discovering, or otherwise receiving data from another computer system. For instance, the wellbore equipment request system 120 may access, query, or communicate with another system, such as through an application programming interface (API) or similar means, for obtaining the additional information.

In some cases, the function calls may include calling or utilizing one or more functions to generate, synthesize, or create additional information. For example, the wellbore equipment request system 120 may call one or more functions for performing analyses on data (e.g., dynamic wellbore data 158). For instance, the wellbore equipment request system 120 may analyze real time measurement data received from the wellbore equipment as described herein and may determine one or more trends, relationships, features, and/or assumptions, based on the data. The function calling may perform calculations (e.g., statistical calculations), clean data, format data, save or store data, generate reports, or other analyses. Performing analysis in this way may involve accessing or communicating with one or more external systems.

In some embodiments, the wellbore equipment request system 120 may call one or more functions for performing simulations. For example, the wellbore equipment request system 120 may simulate a process, operation, condition, or function of a downhole tool or system. Simulations may be performed based on real time data and/or synthetic (e.g., planned, potential, or experimental) data. For instance, the wellbore equipment request system 120 may simulate how a change to the operation of wellbore equipment may affect an operational condition of the wellbore. In a particular example, a downhole tool may be showing inconsistent torque readings, and the wellbore equipment request system 120 can call one or more functions to perform a simulation that can check for downhole stalling. In this way, calling simulation functions may facilitate characterizing, optimizing, or improving the operation of the wellbore equipment.

In this way, the wellbore equipment request system 120 may call one or more functions in order to obtain information related to the wellbore equipment request 152 that was not initially found in the vector index 135 and/or not included in the equipment documents. In some cases, the wellbore equipment request system 120 may be configured with a list or set of functions that it may call to resolve a lack of relevant vector embeddings 134 as just described. For example, the wellbore equipment request system 120 may call the functions in the set in a particular order, obtaining new information and generating new vector embeddings until a set of vector embeddings are found that are sufficiently similar to the wellbore equipment request 152. In some cases, the wellbore equipment request system 120 selects one or more functions from the set of functions to call which will likely be most responsive to the obtaining relevant information. For example, based on the semantic meaning of the wellbore equipment request 152 (e.g., the wellbore query vector embedding) the wellbore equipment request system 120 may select a function from the set which is most likely to obtain relevant information.

As shown in FIG. 2-4, in some cases the wellbore equipment request system 120 receives dynamic wellbore data 158. The dynamic wellbore data 158 may be measurement data and/or real-time data received for the wellbore equipment. For instance, the dynamic wellbore data 158 can include measurement data from any tool, system, sensor, process, or operation of the wellbore. As an example, the dynamic wellbore data 158 can include operational parameters for the wellbore, such as weight on bit (WOB), torque, rotational speed (RPM), pressure, temperature, measurement depth, inclination, azimuth, or other measurements associated with a bit or bottom hole assembly (BHA) of a wellbore or drilling operation. The dynamic wellbore data 158 can include survey and/or formation measurements such as resistivity, gamma ray, porosity, permeability, neutron density, or other formation measurements. The dynamic wellbore data 158 may include measurements associated with a fluid (e.g., production fluid, wellbore fluid, drilling fluid, etc.) such as density, viscosity, temperature, pressure, flowrate, or other property. Indeed, the dynamic wellbore data 158 may include any measurement and/or real-time data which may be collected and transmitted by one or more tools, components, equipment, systems, or processes of the wellbore. The dynamic wellbore data 158 may be received as image data, time-series data, tabular data, or other type of data. In some cases, the dynamic wellbore data 158 may represent and/or may also include historical wellbore data, such a store of dynamic wellbore data for the wellbore (or other wellbores) over a past period of time.

In some embodiments, the wellbore equipment request system 120 may incorporate the dynamic wellbore data 158 for providing to the generative AI model 117 and for generating the wellbore equipment response 154. For example, the wellbore equipment request system 120 may embed the dynamic wellbore data 158 into a same embedding space as the vector index 135. The wellbore equipment request system 120 may embed the dynamic wellbore data 158 using one or more embedding models, such as various embedding models for embedding images, time-series data, and/or tabular data. In some cases, a multi-modal embedding model may be used for embedding any of a variety of types of measurement data. In this way, the dynamic wellbore data 158 may be embedded to relate to the context and/or semantic meaning of the information in the vector index 135.

In some embodiments, the wellbore equipment request 152 may be associated with or related to some of the dynamic wellbore data 158. For example, the wellbore equipment request 152 may specifically query about some of the dynamic wellbore data 158 such as querying how the data relates to a particular wellbore equipment or the operation or health thereof. As an example, the wellbore equipment request 152 may query, with reference to the associated dynamic wellbore data 158, about what is happening to a downhole tool, about characterizing the behavior of a downhole tool, or about why the downhole tool is behaving in a particular way. In another example, the wellbore equipment request 152 may query, based on reference to the associated dynamic wellbore data 158, whether a downhole tool should continue to be operated, whether an operation, mode, or setting of a downhole tool should be changed, or identifying potential outcomes of operating a downhole tool in a particular way. Based on the knowledge in the equipment documents as represented by the vector index 135, the generative AI model 117 may accordingly generate a wellbore equipment response 154 responsive to any of these queries.

The wellbore equipment request system 120 may provide all of the dynamic wellbore data 158 to the generative AI model 117 or may identify a subset of the dynamic wellbore data 158 for providing, for instance, based on the semantic meaning of the wellbore equipment request 152. For instance, the wellbore equipment request system 120 may identify a subset (some or all) of the embedded dynamic wellbore data that is sufficiently close to the wellbore query vector embedding in the vector index 135, and may provide this subset (e.g., the embedded data or the original data) to the generative AI model 117.

Based on the dynamic wellbore data 158 (e.g., and the extracted vector data 151), the generative AI model 117 may generate the wellbore equipment response 154. For example, the wellbore equipment request 152 may query about a specific tool, process, system, etc., and the generative AI model 117 may rely on related information in the dynamic wellbore data 158 to generate the wellbore equipment response 154 which may describe, characterize, troubleshoot, alert to, provide suggestions for modifying, etc., the tool process or system or an operation thereof. For instance, based on the information related to the tool, process, or system in the equipment documents as represented in the vector index 135, the generative AI model 117 may interpret or characterize the related dynamic wellbore data 158.

In a particular example, the wellbore equipment response 154 may identify that a particular tool, process, or system is operating outside of a given threshold (e.g., as determined from the equipment documents) such that a wellbore operation may perform poorly, cause damage, not follow a plan or specification, miss a target, fail, or otherwise behave incorrectly. In some cases, the wellbore equipment response 154 may identify that a particular tool, process, or system is operating inefficiently, or can be operated to a further extent while remaining within a specific threshold and/or without incurring risk of damage or misuse. In some cases, the wellbore equipment response 154 provides a determination or calculation of the average drilling hours saved when applying the suggested or recommended changes or recommended drilling settings to the downhole tool in comparison to the average drilling hours when not making any changes.

In this way, the wellbore equipment response 154 may facilitate characterizing and/or understanding the operation of wellbore equipment by relying on a base of information included in the equipment documents, while also applying particularly to the observable operational conditions indicated by the dynamic wellbore data 158. For instance, the wellbore equipment response 154 may provide a plain language response to a user for understanding and/or adjusting the operation of wellbore equipment. In at least one embodiment, the wellbore equipment request system 120 may rely on historical data to provide wellbore equipment responses 154 and/or perform actions for situations where the active state or condition of the dynamic wellbore data 158 is not addressed sufficiently by the information in the equipment documents. For example, the downhole tool may be behaving out of specification, or may have exceeded one or more thresholds such that ranges or suggestions in the equipment documents (manual) may not appear to be relevant or applicable to a given situation. Accordingly, the wellbore equipment request system 120 can identify, from the historical data, past situations that may be similar or applicable, and may determine recommendations or techniques for the downhole tool (e.g., based on past changes that were successful in remediating the downhole tool behavior).

In some embodiments, the wellbore equipment request system 120 may operate in an automated manner to perform one or more automatic functions, for example, without user intervention or user input. For instance, as mentioned above, in some cases the wellbore equipment request system 120 may be in communication with one or more wellbore equipment systems which may monitor, manage, and/or control the operation of the wellbore equipment. In some cases, the wellbore equipment system(s) may generate and provide the wellbore equipment request 152 to the wellbore equipment request system 120 and may receive the wellbore equipment response 154 (either directly from the generative AI model 117 or from the wellbore equipment request system 120). The wellbore equipment request system 120 and the wellbore equipment system(s) may operate in this way autonomously and/or automatically in order to perform one or more automatic and/or non-user-initiated functions.

As an illustrative example, a wellbore equipment system may query the wellbore equipment request system 120 in order to request (e.g., based on the knowledge provided by the equipment document and/or function call) information regarding the operation of the wellbore equipment. For example, the wellbore equipment system(s) may periodically generate wellbore equipment requests 152 and/or may generate wellbore equipment request 152 in response to one or more identifiable conditions or triggers of associated wellbore equipment. For instance, a wellbore equipment system may query about how efficiently or safely certain wellbore equipment is operating, about why certain wellbore equipment is behaving a certain way, about how to troubleshoot or improve the operation of certain wellbore equipment, etc. Based on the wellbore equipment response 154, the wellbore equipment request system 120 and/or the wellbore equipment system(s) may generate a notification, alert, alarm, or the like. For example, the wellbore equipment response 154 may indicate that a tool, process, or system is operating inefficiently, in a harmful manner, out of specification, or otherwise outside of a given threshold, as determined based on the knowledge in the equipment documents and/or based on the dynamic wellbore data 158. In some cases, the wellbore equipment response 154 may provide a suggestion, recommendation, or steps for actions for operating the wellbore equipment, such as for improving, optimizing, troubleshooting, fixing, or otherwise modifying the operation of wellbore equipment. In at least one embodiment, a wellbore equipment system may automatically generate a wellbore equipment request 152 which may query regarding the operation of a downhole tool or wellbore operation, and the wellbore equipment response 154 may indicate that the downhole tool or wellbore operation is operating outside of a given threshold as determined from the knowledge in the vector index 135, and accordingly a notification or alert may be automatically generated for providing to a client device, presenting on a display, or notifying to a user. In some cases, the wellbore equipment response 154 may provide recommendations or suggestions for modifying or adjusting the tool or operations for returning to or maintaining the operation within the associated threshold.

In some embodiments, the wellbore equipment request system 120 may be utilized in facilitating an automatic operation and/or adjustment of the wellbore equipment. For example, instead of a wellbore equipment response 154 indicating a suggested or recommended adjustment or change to the wellbore equipment, the wellbore equipment response 154 may provide a signal, command, or instruction for facilitating the wellbore equipment system(s) adjusting the wellbore equipment automatically and/or without user intervention. As an illustrative example, a wellbore equipment system may generate a wellbore equipment request 152 and provide the request to the wellbore equipment request system 120. The wellbore equipment request 152 may be associated with analyzing or characterizing the behavior of a downhole tool, such as a steering tool or steering system, bottom hole assembly, or other tool. The wellbore equipment request system 120 (via the generative AI model 117) may facilitate providing a wellbore equipment response 154, which in some cases may be based on real time data for the downhole tool indicated in the dynamic wellbore data 158. The generative AI model 117 may identify, that the downhole tool is operating outside of (e.g., or close to, trending towards, etc.) one or more thresholds for that tool or operation as determined based on the knowledge base of the equipment documents represented in the vector index 135. The generative AI model 117 may generate the wellbore equipment response 154 which may include an adjustment, correction, change, or modification to the tool or operation in order to return or maintain the tool or operation within the threshold. The adjustment or correction may be communicated as a signal, command, instruction, or other response to the wellbore equipment system(s) (e.g., either by the wellbore equipment request system 120 and/or as part of the wellbore equipment response 154) which may cause the wellbore equipment system(s) to implement the adjustment and change the operation of the tool. In some cases, a wellbore equipment response 154 may include a notification indicating that a change or adjustment has been automatically made to a tool or process, for example, for presenting to a user via a display of a client device.

Any (or all) parts of this process of identifying a change to be made, and implementing the change, may be automated such that the change is not initiated or caused by user intervention. For example, the wellbore equipment system(s) may periodically query the wellbore equipment request system 120 to inquire whether an associated tool or process (e.g., given the dynamic wellbore data 158) is operating correctly. In another example, a wellbore equipment system may query the wellbore equipment request system 120 based on a trigger or other event causing the wellbore equipment system to do so. For instance, a wellbore equipment system may query the wellbore equipment request system 120 based on identifying one or more downhole parameters that are outside of a given threshold, and the wellbore equipment request system 120 may inquire what steps to take or adjustments to make to return the tool back to within the given threshold (e.g., and automatically implement those adjustments). In this way, the wellbore equipment request system 120 may form a knowledge or information base for performing automatic adjustments to the operation of wellbore equipment.

In some embodiments, the wellbore equipment request system 120 may connect to or access one or more other automated systems, such as topside and/or downhole automation systems (e.g., autonomous drilling systems). The wellbore equipment request system 120 may receive measurement data (e.g., real time) or other information from these autonomous systems. In some embodiments, the wellbore equipment request system 120 can query the vector index related to the operation of these autonomous systems and may determine, based on the information in the equipment documents, a state or status of the automation, a characterization of the automation, etc. For example, the wellbore equipment request system 120 may determine whether and to what extent an autonomous drilling/steering system is operating within certain operational thresholds, is operating in accordance with a drill plan or planned trajectory, etc. In some cases, the wellbore equipment request system 120 can determine when one of these autonomous systems is operating incorrectly, erroneously, inefficiently, or is otherwise exhibiting an undesirable behavior, and may generate a flag or alert via an equipment content response 154. In some cases, the equipment content response 154 may identify or indicate the behavior of the autonomous system, the cause of the behavior, one or more recommendations for remediating the behavior, etc. In this way, the wellbore equipment request system 120 may operate in conjunction with one or more other automated systems in order to leverage the knowledge based of the equipment documents to monitor and/or improve the automation of other systems.

FIG. 3 illustrates a flow diagram for a method 300 or a series of acts for generating wellbore equipment responses using a generative AI model, according to at least one embodiment of the present disclosure. While FIG. 3 illustrates acts according to one embodiment, alternative embodiments may add to, omit, reorder, or modify any of the acts of FIG. 3. In some embodiments, the acts of FIG. 3 are performed as a computer-implemented method. In some embodiments, the acts of FIG. 3 are performed by a computing system. In some embodiments, the acts of FIG. 3 are performed as instructions stored on a computer-readable storage medium.

In some embodiments, the method 300 includes an act 310 of generating a vector index of vector embeddings. For example, in some cases the act 310 includes generating a vector index of vector embeddings by using an embedding model to create the vector embeddings of equipment documents from a repository of equipment documents for wellbore equipment.

In some embodiments, the method 300 includes an act 320 of generating a wellbore query vector embedding. For example, in some cases the act 320 includes generating a wellbore query vector embedding using the embedding model and based on receiving a wellbore equipment request.

In some embodiments, the method 300 includes an act 330 of comparing the wellbore query vector embedding to the vector index. For example, in some cases the act 330 includes comparing the wellbore query vector embedding to the vector index to identify a subset of the vector embeddings in the vector index that match a semantic meaning of the wellbore equipment request.

In some embodiments, the method 300 includes an act 340 of providing a subset of the vector embeddings and a wellbore equipment prompt to a generative AI model. For example, in some cases the act 340 includes providing the subset of vector embeddings and a wellbore equipment prompt generated based on the wellbore equipment request to a generative AI model, the wellbore equipment prompt including instructions for the generative AI model to generate a wellbore equipment response using the subset of vector embeddings from the vector index.

In some embodiments, the method 300 includes an act 350 of providing a wellbore equipment response to a client device. For example, in some cases, the act 350 includes, based on receiving the wellbore equipment response from the generative AI model, providing the wellbore equipment response to a client device.

In some embodiments, the method 300 further includes generating a first vector embedding of the vector embeddings based on a first equipment document of the equipment documents, generating metadata for the first equipment document, the metadata including context information for content of the first equipment document, and associating the metadata for the first equipment document with the first vector embedding in the vector index. In some embodiments, the context information of the content of the first equipment document identifies one or more of a document location of the first equipment document within the repository, a location within the first equipment document associated with the first vector embedding, or a section heading within the first equipment document associated with the first vector embedding. In some embodiments, the method 300 further includes segmenting text of the equipment documents into blocks, wherein the vector embeddings are created based on the blocks.

In some embodiments, the wellbore equipment includes downhole steering equipment. In some embodiments, the equipment documents include one or more of an operating manual, a concept manual, a service manual, or a specification manual for the wellbore equipment. In some embodiments, the equipment documents are of a first data format, and the dynamic wellbore data is of a second data format different from the first data format, and generating the wellbore data vector embedding is performed using a wellbore data embedding model that maps data of the second data format to the vector index. In some embodiments, the first data format is text data, and the second data format is one or more of time-series data, image data, or tabular data.

In some embodiments, the method 300 further includes generating a wellbore data vector embedding based on receiving dynamic wellbore data associated with the wellbore equipment request, and providing the wellbore data vector embedding to the generative AI model with the subset of vector embeddings and the wellbore equipment prompt for generating the wellbore equipment response using the subset of vector embeddings and the wellbore data vector embedding, wherein the wellbore equipment request is related to an operational condition of a wellbore associated with the dynamic wellbore data. In some embodiments, the dynamic wellbore data is real time wellbore data received from a downhole tool implemented at the wellbore.

In some embodiments, the wellbore equipment request is received from a wellbore equipment request system that manages a wellbore operation of wellbore equipment, wherein the wellbore equipment request system generates the wellbore equipment request automatically and without user involvement, and wherein the wellbore equipment request is associated with the wellbore operation in relation to the dynamic wellbore data. In some embodiments, the wellbore equipment response indicates that one or more parameters of the wellbore operation as indicated in the dynamic wellbore data is outside of an associated threshold determined from the vector embeddings of the equipment documents, and the method 300 further includes generating, automatically and without user involvement, an associated notification for the wellbore operation. In some embodiments, the wellbore equipment response indicates, based on the vector embeddings of the equipment documents, directions for adjusting the wellbore equipment that maintains the one or more parameters of the wellbore operation within the associated threshold, and the method 300 further includes providing the directions to the client device automatically and without user intervention. In some embodiments, the wellbore equipment response indicates, based on the vector embeddings of the equipment documents, an adjustment for the wellbore equipment that maintains the one or more parameters of the wellbore operation within the associated threshold, and further comprising, automatically and without user intervention, providing a signal to the wellbore equipment request system to implement the adjustment at the wellbore equipment, wherein the notification indicates that the wellbore equipment has been automatically adjusted.

In some embodiments, the subset of vector embeddings that match the semantic meaning of the wellbore equipment request are not initially included in the vector index, and the method further includes, based on comparing the wellbore query vector embedding to the vector index, determining that no vector embeddings in the vector index match the semantic meaning of the wellbore equipment request to a sufficient threshold, generating one or more additional vector embeddings in the vector index for additional wellbore equipment information based on calling a function to obtain the additional wellbore equipment information that is not included in the equipment documents, and identifying the subset of vector embeddings in the vector index that match the semantic meaning of the wellbore equipment request, the subset of vector embeddings including the one or more additional vector embeddings. In some embodiments, calling the function includes selecting the function from a set of functions based on the semantic meaning of the wellbore equipment request. In some embodiments, calling the function includes one or more of receiving information from another computer system, performing an analysis on wellbore equipment, or performing a simulation of a wellbore operation.

In some embodiments, the method further includes providing the subset of vector embeddings and the wellbore equipment request to a large language model (LLM), and receiving, from the LLM, the wellbore equipment response including a natural language response related to an operation of downhole steering equipment responsive to the wellbore equipment request.

Turning now to FIG. 4, this figure illustrates certain components that may be included within a computer system 400. One or more computer systems 400 may be used to implement the various devices, components, and systems described herein.

The computer system 400 includes a processor 401. The processor 401 may be a general-purpose single-or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 401 may be referred to as a central processing unit (CPU). Although just a single processor 401 is shown in the computer system 400 of FIG. 4, in an alternative configuration, a combination of processors (e.g., an ARM and DSP) could be used.

The computer system 400 also includes memory 403 in electronic communication with the processor 401. The memory 403 may include computer-readable storage media and can be any available media that can be accessed by a general purpose or special purpose computer system. Computer-readable media that store computer-executable instructions are non-transitory computer-readable media (device). Computer-readable media that carry computer-executable instructions are transmission media. Thus, by way of example and not limitations, embodiment of the present disclosure can comprise at least two distinctly different kinds of computer-readable media: non-transitory computer-readable media (devices) and transmission media.

Both non-transitory computer-readable media (devices) and transmission media may be used temporarily to store or carry software instructions in the form of computer readable program code that allows performance of embodiments of the present disclosure. Non-transitory computer-readable media may further be used to persistently or permanently store such software instructions. Examples of non-transitory computer-readable storage media include physical memory (e.g., RAM, ROM, EPROM, EEPROM, etc.), optical disk storage (e.g., CD, DVD, HDDVD, Blu-ray, etc.), storage devices (e.g., magnetic disk storage, tape storage, diskette, etc.), flash or other solid-state storage or memory, or any other non-transmission medium which can be used to store program code in the form of computer-executable instructions or data structures and which can be accessed by a general purpose or special purpose computer, whether such program code is stored or in software, hardware, firmware, or combinations thereof.

Instructions 405 and data 407 may be stored in the memory 403. The instructions 405 may be executable by the processor 401 to implement some or all of the functionality disclosed herein. Executing the instructions 405 may involve the use of the data 407 that is stored in the memory 403. Any of the various examples of modules and components described herein may be implemented, partially or wholly, as instructions 405 stored in memory 403 and executed by the processor 401. Any of the various examples of data described herein may be among the data 407 that is stored in memory 403 and used during execution of the instructions 405 by the processor 401.

A computer system 400 may also include one or more communication interfaces 409 for communicating with other electronic devices. The communication interface(s) 409 may be based on wired communication technology, wireless communication technology, or both. Some examples of communication interfaces 409 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

The communication interfaces 409 may connect the computer system 400 to a network. A “network” or “communications network” may generally be defined as one or more data links that enable the transport of electronic data between computer systems and/or modules, engines, or other electronic devices, or combinations thereof. When information is transferred or provided over a communication network or another communications connection (either hardwired, wireless, or a combination of hardwired or wireless) to a computing device, the computing device properly views the connection as a transmission medium. Transmission media can include a communication network and/or data links, carrier waves, wireless signals, and the like, which can be used to carry desired program or template code means or instructions in the form of computer-executable instruction or data structures and which can be accessed by a general purpose or special purpose computer.

A computer system 400 may also include one or more input devices 411 and one or more output devices 413. Some examples of input devices 411 include a keyboard, mouse, microphone, remote control device, button, joystick, trackball, touchpad, and lightpen. Some examples of output devices 413 include a speaker and a printer. One specific type of output device that is typically included in a computer system 400 is a display device 415. Display devices 415 used with embodiments disclosed herein may utilize any suitable image projection technology, such as liquid crystal display (LCD), light-emitting diode (LED), gas plasma, electroluminescence, or the like. A display controller 417 may also be provided, for converting data 407 stored in the memory 403 into one or more of text, graphics, or moving images (as appropriate) shown on the display device 415.

The various components of the computer system 400 may be coupled together by one or more buses, which may include one or more of a power bus, a control signal bus, a status signal bus, a data bus, other similar components, or combinations thereof. For the sake of clarity, the various buses are illustrated in FIG. 4 as a bus system 419.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Further, upon reaching various computer system components, program code in the form of computer-executable instructions or data structures can be transferred automatically or manually from transmission media to non-transitory computer-readable storage media (or vice versa). For example, computer-executable instructions or data structures received over a network or data link can be buffered in memory (e.g., RAM) within a network interface module (NIC), and then eventually transferred to computer system RAM and/or to less volatile non-transitory computer-readable storage media at a computer system. Thus, it should be understood that non-transitory computer-readable storage media can be included in computer system components that also (or even primarily) utilize transmission media.

### INDUSTRIAL APPLICABILITY

The following description from paragraphs [0105]-[0125] includes various embodiments that, where feasible, may be combined in any permutation. For example, the embodiment of paragraph [0105] may be combined with any or all embodiments of the following paragraphs. Embodiments that describe acts of a method may be combined with embodiments that describe, for example, systems and/or devices. Any permutation of the following paragraphs is considered to be hereby disclosed for the purposes of providing “unambiguously derivable support” for any claim amendment based on the following paragraphs. Furthermore, the following paragraphs provide support such that any combination of the following paragraphs would not create an “intermediate generalization.”

In some embodiments, a method for generating wellbore equipment responses using a generative artificial intelligence (AI) model includes generating a vector index of vector embeddings by using an embedding model to create the vector embeddings of equipment documents from a repository of equipment documents for wellbore equipment, generating a wellbore query vector embedding using the embedding model and based on receiving a wellbore equipment request, comparing the wellbore query vector embedding to the vector index to identify a subset of the vector embeddings in the vector index that match a semantic meaning of the wellbore equipment request, providing the subset of vector embeddings and a wellbore equipment prompt generated based on the wellbore equipment request to a generative AI model, the wellbore equipment prompt including instructions for the generative AI model to generate a wellbore equipment response using the subset of vector embeddings from the vector index, and based on receiving the wellbore equipment response from the generative AI model, providing the wellbore equipment response to a client device.

In some embodiments, the method includes identifying the repository of equipment documents.

In some embodiments, the method further includes generating a first vector embedding of the vector embeddings based on a first equipment document of the equipment documents, generating metadata for the first equipment document, the metadata including context information for content of the first equipment document, and associating the metadata for the first equipment document with the first vector embedding in the vector index.

In some embodiments, the context information of the content of the first equipment document identifies one or more of a document location of the first equipment document within the repository, a location within the first equipment document associated with the first vector embedding, or a section heading within the first equipment document associated with the first vector embedding.

In some embodiments, the method further includes segmenting text of the equipment documents into blocks, wherein the vector embeddings are created based on the blocks.

In some embodiments, wherein the wellbore equipment includes downhole steering equipment.

In some embodiments, the equipment documents include one or more of an operating manual, a concept manual, a service manual, or a specification manual for the wellbore equipment.

In some embodiments, the method further includes generating a wellbore data vector embedding based on receiving dynamic wellbore data associated with the wellbore equipment request, and providing the wellbore data vector embedding to the generative AI model with the subset of vector embeddings and the wellbore equipment prompt for generating the wellbore equipment response using the subset of vector embeddings and the wellbore data vector embedding, wherein the wellbore equipment request is related to an operational condition of a wellbore associated with the dynamic wellbore data.

In some embodiments, the dynamic wellbore data is real time wellbore data received from a downhole tool implemented at the wellbore.

In some embodiments, the equipment documents are of a first data format, and the dynamic wellbore data is of a second data format different from the first data format, and generating the wellbore data vector embedding is performed using a wellbore data embedding model that maps data of the second data format to the vector index.

In some embodiments, the first data format is text data, and the second data format is one or more of time-series data, image data, or tabular data.

In some embodiments, the wellbore equipment request is received from a wellbore equipment request system that manages a wellbore operation of wellbore equipment, wherein the wellbore equipment request system generates the wellbore equipment request automatically and without user involvement, and wherein the wellbore equipment request is associated with the wellbore operation in relation to the dynamic wellbore data.

In some embodiments, the wellbore equipment response indicates that one or more parameters of the wellbore operation as indicated in the dynamic wellbore data is outside of an associated threshold determined from the vector embeddings of the equipment documents, and further comprising generating, automatically and without user involvement, an associated notification for the wellbore operation.

In some embodiments, the wellbore equipment response indicates, based on the vector embeddings of the equipment documents, directions for adjusting the wellbore equipment that maintains the one or more parameters of the wellbore operation within the associated threshold, and further comprising providing the directions to the client device automatically and without user intervention.

In some embodiments, the wellbore equipment response indicates, based on the vector embeddings of the equipment documents, an adjustment for the wellbore equipment that maintains the one or more parameters of the wellbore operation within the associated threshold, and further comprising, automatically and without user intervention, providing a signal to the wellbore equipment request system to implement the adjustment at the wellbore equipment, wherein the notification indicates that the wellbore equipment has been automatically adjusted.

In some embodiments, the subset of vector embeddings that match the semantic meaning of the wellbore equipment request are not initially included in the vector index, and further comprising, based on comparing the wellbore query vector embedding to the vector index, determining that no vector embeddings in the vector index match the semantic meaning of the wellbore equipment request to a sufficient threshold, generating one or more additional vector embeddings in the vector index for additional wellbore equipment information based on calling a function to obtain the additional wellbore equipment information that is not included in the equipment documents, and identifying the subset of vector embeddings in the vector index that match the semantic meaning of the wellbore equipment request, the subset of vector embeddings including the one or more additional vector embeddings.

In some embodiments, calling the function includes selecting the function from a set of functions based on the semantic meaning of the wellbore equipment request.

In some embodiments, calling the function includes one or more of receiving information from another computer system, performing an analysis on wellbore equipment, or performing a simulation of a wellbore operation.

In some embodiments, the method further includes providing the subset of vector embeddings and the wellbore equipment request to a large language model (LLM), and receiving, from the LLM, the wellbore equipment response including a natural language response related to an operation of downhole steering equipment responsive to the wellbore equipment request.

In some embodiments, a system includes at least one processor, memory in electronic communication with the at least one processor, and instructions stored in the memory, the instructions being executable by the at least one processor to identify a repository including equipment documents for wellbore equipment, generate a vector index of vector embeddings by using an embedding model to create the vector embeddings of the equipment documents, generate a wellbore query vector embedding using the embedding model and based on receiving a wellbore equipment request, compare the wellbore query vector embedding to the vector index to identify a subset of the vector embeddings in the vector index that match a semantic meaning of the wellbore equipment request, provide the subset of vector embeddings and a wellbore equipment prompt generated based on the wellbore equipment request to a generative AI model, the wellbore equipment prompt including instructions for the generative AI model to generate a wellbore equipment response using the subset of vector embeddings from the vector index, and based on receiving the wellbore equipment response from the generative AI model, provide the wellbore equipment response to a client device.

In some embodiments, a non-transitory computer-readable storage medium includes instructions that, when executed by a processor, cause the processor to identify a repository including equipment documents for wellbore equipment, generate a vector index of vector embeddings by using an embedding model to create the vector embeddings of the equipment documents, generate a wellbore query vector embedding using the embedding model and based on receiving a wellbore equipment request, compare the wellbore query vector embedding to the vector index to identify a subset of the vector embeddings in the vector index that match a semantic meaning of the wellbore equipment request, provide the subset of vector embeddings and a wellbore equipment prompt generated based on the wellbore equipment request to a generative AI model, the wellbore equipment prompt including instructions for the generative AI model to generate a wellbore equipment response using the subset of vector embeddings from the vector index, and based on receiving the wellbore equipment response from the generative AI model, provide the wellbore equipment response to a client device.

The embodiments of the wellbore equipment request system have been primarily described with reference to wellbore drilling operations; the wellbore equipment request system described herein may be used in applications other than the drilling of a wellbore. In other embodiments, the wellbore equipment request system according to the present disclosure may be used outside a wellbore or other downhole environment used for the exploration or production of natural resources. For instance, the wellbore equipment request system of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers'specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any and all combinations of one or more of the associated listed items.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for generating wellbore equipment responses using a generative artificial intelligence (AI) model, comprising:
generating a vector index of vector embeddings by using an embedding model to create the vector embeddings of equipment documents from a repository of equipment documents for wellbore equipment;
generating a wellbore query vector embedding using the embedding model and based on receiving a wellbore equipment request;
comparing the wellbore query vector embedding to the vector index to identify a subset of the vector embeddings in the vector index that match a semantic meaning of the wellbore equipment request;
providing the subset of vector embeddings and a wellbore equipment prompt generated based on the wellbore equipment request to a generative AI model, the wellbore equipment prompt including instructions for the generative AI model to generate a wellbore equipment response using the subset of vector embeddings from the vector index; and
based on receiving the wellbore equipment response from the generative AI model, providing the wellbore equipment response to a client device.

2. The method of claim 1, further comprising:
generating a first vector embedding of the vector embeddings based on a first equipment document of the equipment documents;
generating metadata for the first equipment document, the metadata including context information for content of the first equipment document; and
associating the metadata for the first equipment document with the first vector embedding in the vector index.

3. The method of claim 2, wherein the context information of the content of the first equipment document identifies one or more of a document location of the first equipment document within the repository, a location within the first equipment document associated with the first vector embedding, or a section heading within the first equipment document associated with the first vector embedding.

4. The method of claim 1, further comprising segmenting text of the equipment documents into blocks, wherein the vector embeddings are created based on the blocks.

5. The method of claim 1, wherein the wellbore equipment includes downhole steering equipment.

6. The method of claim 1, wherein the equipment documents include one or more of an operating manual, a concept manual, a service manual, or a specification manual for the wellbore equipment.

7. The method of claim 1, further comprising generating a wellbore data vector embedding based on receiving dynamic wellbore data associated with the wellbore equipment request, and providing the wellbore data vector embedding to the generative AI model with the subset of vector embeddings and the wellbore equipment prompt for generating the wellbore equipment response using the subset of vector embeddings and the wellbore data vector embedding, wherein the wellbore equipment request is related to an operational condition of a wellbore associated with the dynamic wellbore data.

8. The method of claim 7, wherein the dynamic wellbore data is real time wellbore data received from a downhole tool implemented at the wellbore.

9. The method of claim 7, wherein the equipment documents are of a first data format, and the dynamic wellbore data is of a second data format different from the first data format, and generating the wellbore data vector embedding is performed using a wellbore data embedding model that maps data of the second data format to the vector index.

10. The method of claim 9, wherein the first data format is text data, and the second data format is one or more of time-series data, image data, or tabular data.

11. The method of claim 7, wherein the wellbore equipment request is received from a wellbore equipment request system that manages a wellbore operation of wellbore equipment, wherein the wellbore equipment request system generates the wellbore equipment request automatically and without user involvement, and wherein the wellbore equipment request is associated with the wellbore operation in relation to the dynamic wellbore data.

12. The method of claim 11, wherein the wellbore equipment response indicates that one or more parameters of the wellbore operation as indicated in the dynamic wellbore data is outside of an associated threshold determined from the vector embeddings of the equipment documents, and further comprising generating, automatically and without user involvement, an associated notification for the wellbore operation.

13. The method of claim 12, wherein the wellbore equipment response indicates, based on the vector embeddings of the equipment documents, directions for adjusting the wellbore equipment that maintains the one or more parameters of the wellbore operation within the associated threshold, and further comprising providing the directions to the client device automatically and without user intervention.

14. The method of claim 12, wherein the wellbore equipment response indicates, based on the vector embeddings of the equipment documents, an adjustment for the wellbore equipment that maintains the one or more parameters of the wellbore operation within the associated threshold, and further comprising, automatically and without user intervention, providing a signal to the wellbore equipment request system to implement the adjustment at the wellbore equipment, wherein the notification indicates that the wellbore equipment has been automatically adjusted.

15. The method of claim 1, wherein the subset of vector embeddings that match the semantic meaning of the wellbore equipment request are not initially included in the vector index, and further comprising:
based on comparing the wellbore query vector embedding to the vector index, determining that no vector embeddings in the vector index match the semantic meaning of the wellbore equipment request to a sufficient threshold;
generating one or more additional vector embeddings in the vector index for additional wellbore equipment information based on calling a function to obtain the additional wellbore equipment information that is not included in the equipment documents; and
identifying the subset of vector embeddings in the vector index that match the semantic meaning of the wellbore equipment request, the subset of vector embeddings including the one or more additional vector embeddings.

16. The method of claim 15, wherein calling the function includes selecting the function from a set of functions based on the semantic meaning of the wellbore equipment request.

17. The method of claim 15, wherein calling the function includes one or more of:
receiving information from another computer system;
performing an analysis on wellbore equipment; or
performing a simulation of a wellbore operation.

18. The method of claim 1, further comprising:
providing the subset of vector embeddings and the wellbore equipment request to a large language model (LLM); and
receiving, from the LLM, the wellbore equipment response including a natural language response related to an operation of downhole steering equipment responsive to the wellbore equipment request.

19. A system, comprising:
at least one processor;
memory in electronic communication with the at least one processor; and
instructions stored in the memory, the instructions being executable by the at least one processor to:
generate a vector index of vector embeddings by using an embedding model to create the vector embeddings of equipment documents from a repository of equipment documents for wellbore equipment;
generate a wellbore query vector embedding using the embedding model and based on receiving a wellbore equipment request;
compare the wellbore query vector embedding to the vector index to identify a subset of the vector embeddings in the vector index that match a semantic meaning of the wellbore equipment request;
provide the subset of vector embeddings and a wellbore equipment prompt generated based on the wellbore equipment request to a generative AI model, the wellbore equipment prompt including instructions for the generative AI model to generate a wellbore equipment response using the subset of vector embeddings from the vector index; and
based on receiving the wellbore equipment response from the generative AI model, provide the wellbore equipment response to a client device.

20. A non-transitory computer-readable storage medium including instructions that, when executed by a processor, cause the processor to:
generate a vector index of vector embeddings by using an embedding model to create the vector embeddings of equipment documents from a repository of equipment documents for wellbore equipment;
generate a wellbore query vector embedding using the embedding model and based on receiving a wellbore equipment request;
compare the wellbore query vector embedding to the vector index to identify a subset of the vector embeddings in the vector index that match a semantic meaning of the wellbore equipment request;
provide the subset of vector embeddings and a wellbore equipment prompt generated based on the wellbore equipment request to a generative AI model, the wellbore equipment prompt including instructions for the generative AI model to generate a wellbore equipment response using the subset of vector embeddings from the vector index; and
based on receiving the wellbore equipment response from the generative AI model, provide the wellbore equipment response to a client device.
